(19) United States
(12) Patent Application Publication
(10) Pub. No.: US 2015/0354649 A1
(43) Pub. Date: Dec. 10, 2015

(54) FRICTION DISK COOLING GROOVES

(71) Applicant: Deere & Company, Moline, IL (US)

(72) Inventor: STEVEN P. FORSSBERG, WATERLOO, IA (US)

(21) Appl. No.: 14/300,370

(22) Filed: Jun. 10, 2014

(51) Int. Cl. F16D 65/12; F16D 13/74; F16D 65/847

(52) U.S. Cl. CPC F16D 65/128; F16D 65/847; F16D 13/74

(57) ABSTRACT

A friction disk for a frictionally acting device includes an annular friction surface having an inner edge and an outer edge. Grooves are formed in the friction surface. The grooves include a plurality of radially extending inner grooves which communicate with the inner edge. A plurality of radially extending outer grooves communicate with the outer edge. A plurality of branch grooves communicate each inner groove with a pair of the outer grooves, and communicate each outer groove with a pair of the inner grooves. Each inner groove is aligned with a corresponding outer groove. Each branch groove intersects with another of the branch grooves. Each inner groove has a width which is greater than a width of a corresponding outer groove.

### FIELD

The present disclosure relates to cooling grooves in a friction disk.

### BACKGROUND

A brake assembly includes a rotating friction plate or disk which engages a non-rotating reaction plate and a piston. The friction disk includes a thin plate with friction material, segmented or un-segmented, attached on at least one side of the friction disk. The piston moves the friction disk into engagement with the reaction plate. This engagement generates heat, and efficient cooling is required to maintain acceptable disk and cooling fluid temperatures.

It is known to form grooves in the friction material so that cooling fluid, such as oil, will flow through the grooves either radially inwardly or outwardly. The grooves pump and transport cooling fluid to aid in cooling the rotating friction disk. Heat is absorbed by the cooling fluid as the cooling fluid passes through the grooves and along the disk outer peripheral edge and disk inner peripheral edge.

Various groove shapes have been used. Known groove shapes or patterns have included multiple parallel (waffle), radial, and sunburst patterns.

U.S. Pat. No. 7,448,483, issued in 2008 to Arcot, et al. shows a clutch with cooling grooves which extend only in the radial direction. The grooves have a largest cross-sectional area located adjacent to a hot area which is located between the cooling fluid inlet and the cooling fluid outlet. The grooves have a smallest cross-sectional area at a cooling fluid inlet which is the coolest location on the disk.

U.S. Pat. No. 4,995,500, issued to Payvar in 1991 shows a groove pattern for high thermal capacity wet clutch. This groove pattern includes one or more circumferential grooves dividing the friction area into two or more annular bands with radial grooves in each band which increase in number from the inner band to the outer band.

It is desired to provide a groove pattern which controls the flow at the groove outlets and which provides a uniform heat transfer. It is desired to provide a groove pattern wherein all inlets pick up oil equally independent of the rotational directions.

### SUMMARY

According to an aspect of the present disclosure, a friction disk for a frictionally acting device includes an annular friction surface having an inner edge and an outer edge. Radially extending inner grooves are formed in the friction surface. Each inner grove communicates with the inner edge. Radially extending outer grooves are formed in the friction surface. Each outer grove communicates with the outer edge. A plurality of branch grooves are also formed in the friction surface. The branch grooves communicate each inner groove with a pair of the outer grooves, and the branch grooves communicate each outer groove with a pair of the inner grooves. Each inner groove is aligned radially with a corresponding outer groove. Each branch groove intersects with another of the branch grooves. Each inner groove has a width which is greater than a width of a corresponding outer groove. Each branch groove is joined to one of the inner grooves and to one of the outer grooves by a smoothly curved transition.

The resulting pattern of wishbone-shaped grooves improves fluid pumping capacity by having radial inlets and outlets. All grooves in this pattern fill with fluid independent of rotational direction. The curvature of the groves increases the length of the groove allowing the fluid to be in contact with the heat source longer. This improves efficiency by maximizing the heat transfer to the fluid allowing for lower mass flow rate for the same heat rejection. A flow restriction is created by converging two inner grooves into a single outer groove. Radially outward flow is also restricted because the inner grooves are wider than the outer grooves. This insures the grooves are filled with fluid and increases heat transfer. The groves are separated by pads with similar areas, which allow even pressure contact and coincident heat rejection. All regions fill coincidently and evenly.

### BRIEF DESCRIPTION OF THE DRAWINGS

FIG. 1 is an exploded perspective view of a rotary friction unit;

FIG. 2 is an exploded perspective view of a rotary friction unit from the opposite side from FIG. 1;

FIG. 3 is an end view of a friction disk of the friction unit of FIG. 1; and

FIG. 4 is an enlarged detailed view of a portion of FIG. 2.

### DETAILED DESCRIPTION OF THE DRAWINGS

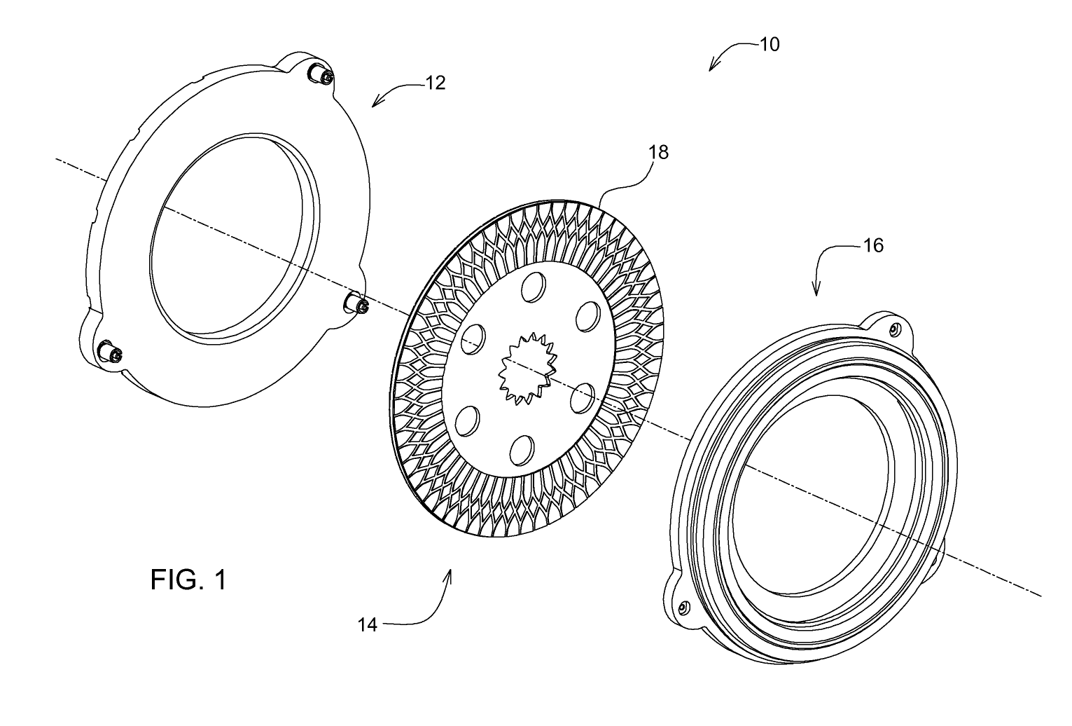

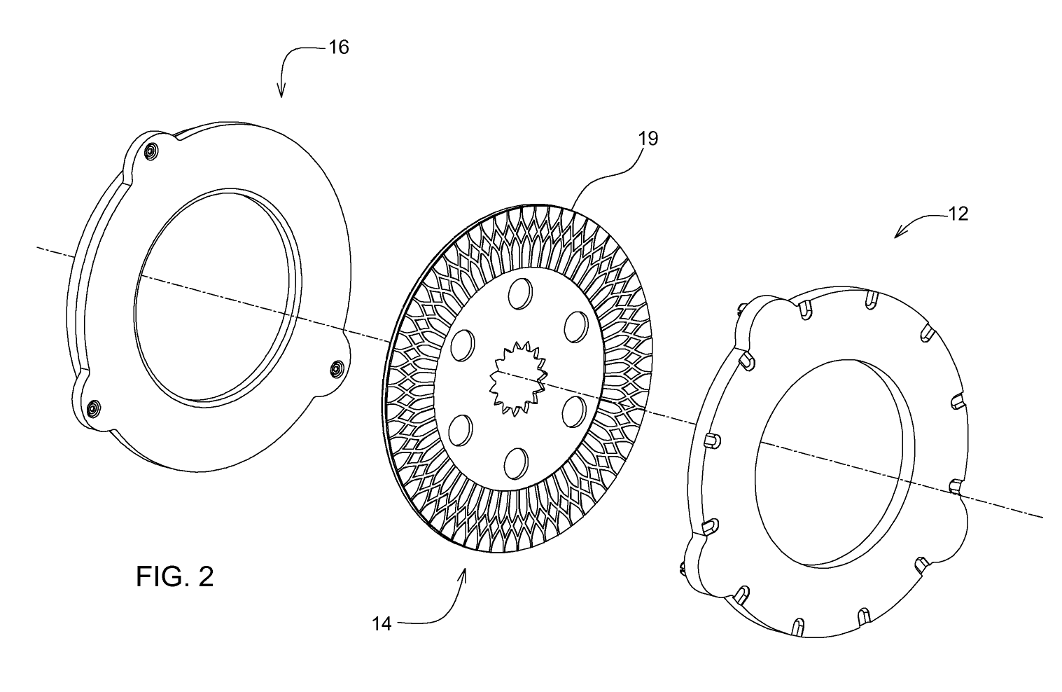

Referring to FIGS. 1 and 2, a friction device, 10, such as a clutch or brake, includes a annular reaction plate 12, a brake or friction disk 14 and a annular brake piston 16. Brake disk 14 includes an annular friction surface 18 which frictionally engages the brake piston 16, and an annular friction surface 19 which frictionally engages the reaction plate 12.

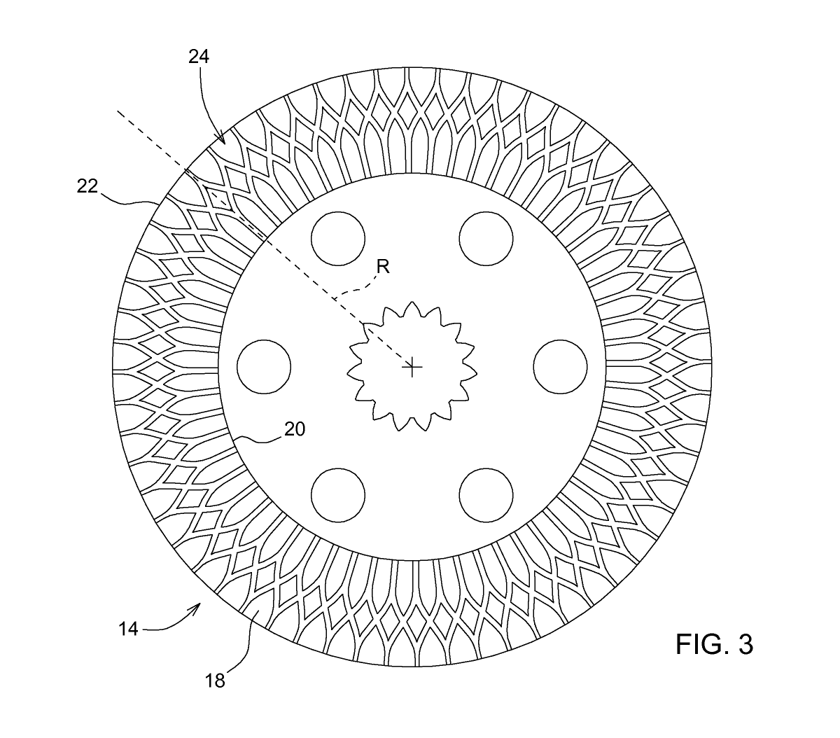

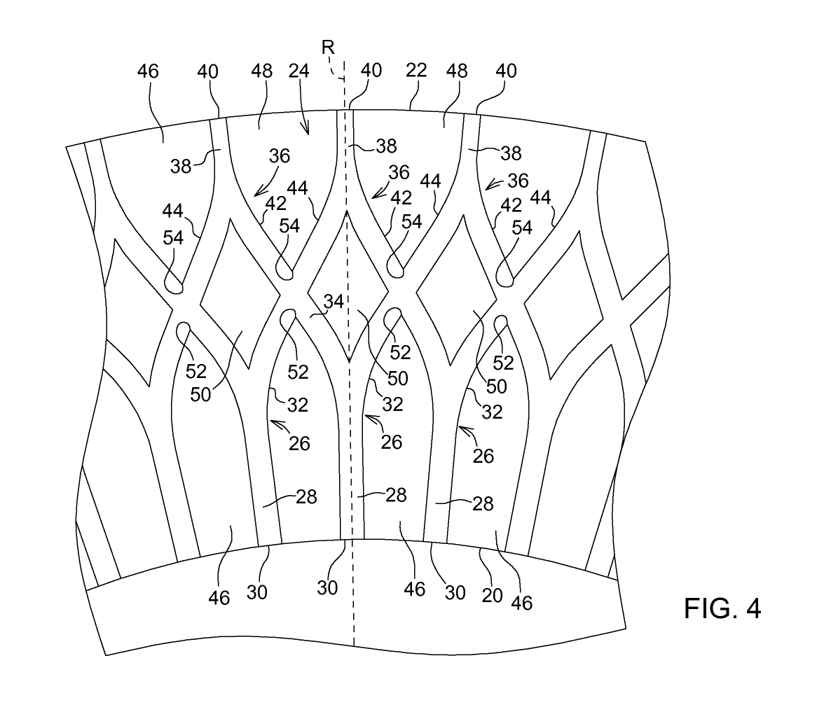

As best seen in FIGS. 3 and 4, the friction surfaces 18 and 19 includes an inner edge 20 and an outer edge 22. A plurality of grooves 24 are formed on both annular friction surfaces 18 and 19. The depth of the grooves may be constant, or it may vary. The maximum groove depth may be related to the thickness of the brake disk 14. In some applications, an appropriate maximum groove depth may be 40% of the thickness of the disk 14.

As best seen in FIGS. 3, the grooves 24 include a plurality of first Y-shaped grooves 26A, 26B, 26C . . . formed in the friction surface 18. Each first Y-shaped groove 26 has a first or inlet port 28 communicating with the inner edge 20, a second or outlet port 30 communicating with the outer edge 22 and a third or outlet port 32 communicating with the outer edge 22. Each first Y-shaped groove 26 has a first branch 34 extending outwardly from the inlet port 28, a second branch 36 communicating the first branch 34 with the outlet port 30 and a third branch 38 communicating the first branch 34 with the outlet port 32. Thus, each of the first Y-shaped grooves 26 has a single inwardly directed branch and a pair of outwardly directed branches which diverge from each other in a radially outwardly direction.

The grooves 24 also include a plurality of second Y-shaped grooves 40A, 40B, 40C . . . formed in the friction surface 18. Each second Y-shaped groove 40 opens inwardly has a fourth or outlet port 42 communicating with the outer edge 22, a fifth or inlet port 44 communicating with the inner edge 20 and a sixth or inlet port 46 communicating with the inner edge 20. Each second Y-shaped groove 40 has a forth branch 48 extending inwardly from the outlet port 42, a fifth branch 50 communicating the fourth branch 48 with the inlet port 44 and a sixth branch 52 communicating the fourth branch 48 with the inlet port 46. Thus, each of the second Y-shaped grooves 26 has a single outwardly directed branch and a pair of inwardly directed branches which diverge from each other in a radially inwardly direction. Also, the second branch 36 intersects with the fifth branch 50, and the third branch 38 intersects with the sixth branch 52.

As best seen in FIGS. 3 and 4, the inlet port 28 and the outlet port 42 are aligned with each other so that a radial line R passes through the ports 28 and 42 and through a center of the friction disk 14.

As best seen in FIG. 3, the inlet port 28 and the first branch 34 of one of the first Y-shaped grooves 26A forms the inlet port 60 and a portion of the fifth branch 62 of an adjacent one 40C of the second Y-shaped grooves 40. The first port 28 and the first branch 34 of one of the first Y-shaped grooves 26 forms the inlet port 60 and a portion of the sixth branch of an adjacent 40B one of the second Y-shaped grooves 40.

The outlet port 42 and the fourth branch 48 of one of the second Y-shaped grooves 40 form the outlet port and a portion of the second branch of an adjacent 26C one of the first Y-shaped grooves 26. The outlet port 42 and the fourth branch 48 of one of the second Y-shaped grooves 40 form the outlet port and a portion of the third branch of an adjacent one 26B of the first Y-shaped grooves 26.

As best seen in FIG. 3, the inlet ports 28, 44, 46 are wider than the outlet ports 30, 32 and 42. The inlet ports 28, 44, 46 extend radially and are perpendicular to the inner edge 20. The outlet ports 30, 32 and 42 extend radially and are perpendicular to the outer edge 22. Each inlet is connected by a curved passage to a pair of outlets. The result is a plurality of radially extending inner grooves 34 formed in the friction surface 18, with each inner grove 34 communicating with the inner edge 20. A plurality of radially extending outer grooves 48 are formed in the friction surface 18, with each outer grove 48 communicating with the outer edge 22. A plurality of interior branch grooves 38, 62 are formed in the friction surface 18. The branch grooves communicate each inner groove 34 with a pair of the outer grooves 48, and the branch grooves communicate each outer groove 48 with a pair of the inner grooves 34.

The arrangement of grooves 24 forms a plurality of inner pads 70, a plurality of outer pads 72 and a plurality of diamond shaped interior pads 74. Inner pads 70 have an arch shape with an outwardly oriented apex 76. Outer pads 72 have an arch shape with an inwardly oriented apex 78.

The result is a pattern of wishbone or Y-shaped grooves which improves fluid pumping capacity by having radially directed inlets and outlets. All grooves in this pattern fill with fluid independent of rotational direction. The curvature of the pattern increases the length of the groove allowing the fluid to be in contact with the heat source longer. This improves efficiency by maximizing the heat transfer to the fluid allowing for lower mass flow rate for the same heat rejection. A flow restriction is created near the outer edge 22 by converging two inlet grooves 34 into one outlet groove 48. The flow restriction is also due to the width of outlet grooves 48 being smaller than the width of the inlet grooves 34, and/or by tapering the grooves from the inner edge 20 to the outer edge 22. This insures the grooves are filled with fluid and increases heat rejection. The wishbone pattern forms pads 7, 72 and 74 with similar areas allowing even pressure contact and coincident heat rejection. All regions fill coincidently and evenly.

The pattern is formed by a repeating a Y-shaped groove. The groove starts at the inner diameter with a straight radial inlet. Fluid enters the groove entrance independent of the rotational direction. Fluid is pumped by centrifugal force or pressure along the groove. The grooved has curvature which increases the groove length allowing for more heat to be transferred to the fluid before the fluid exits the groove. Near the outer diameter, the groove has a straight radial orientation to the outer exit. The other half of the pattern is form by a mirror image of the first groove with the outlet section aligned. This enables the flow restriction to be at the outer diameter and generates pads with similar areas. The pattern can be produced by multiple methods including cutting, pressing or embossing. The pattern allows with varying widths or depth geometries. The resulting pattern looks similar to the shape of a wishbone. The wishbone pattern improves performance over other patterns.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

1. A friction disk for a frictionally acting device, comprising:
a circular plate having a surface to which friction material is fixed to define an annular friction surface having an inner edge and an outer edge;
a plurality of radially extending inner grooves formed in the friction surface, each inner groove communicating with the inner edge and being equal angularly spaced from each other along the inner edge;
a plurality of radially extending outer grooves formed in the friction surface, each outer groove communicating with the outer edge and being equal angularly spaced from each other along the outer edge;
a plurality of groove branches located in an annular region of said friction disk between said plurality of radially extending inner grooves and said radially extending outer grooves, said plurality of groove branches communicating each inner groove with a pair of the outer grooves, and said groove branches communicating each outer groove with a pair of the inner grooves.

2. The friction part of claim 1, wherein:
each inner groove is radially aligned with a corresponding outer groove.

3. The friction part of claim 1, wherein:
each groove branch intersects with another of the groove branches.

4. The friction part of claim 1, wherein:
each inner groove has a width which is greater than a width of a corresponding outer groove.

5. The friction part of claim 1, wherein:
each groove is joined to one of the inner grooves and to one of the outer grooves by a curved transition.

6. A friction disk for a frictionally acting device, comprising:
a circular plate;
an annular region of friction material being attached to at least one surface of the plate and forming a friction surface having an inner edge and an outer edge;
a plurality of first Y-shaped grooves formed in the friction surface for circulating cooling fluid and respectively including first stems having inner ends defining inlet ports located at, and spaced angularly from each other about, the inner edge, each first stem extending outwardly from the first port and being joined to first and second outwardly diverging groove branches;
a plurality of second Y-shaped grooves formed in the friction surface and respectively including second stems having outer ends defining outlet ports located at, and being spaced angularly from each other about, the outer edge, each second stem extending inwardly from the second port and being joined to third and fourth inwardly diverging groove branches;
the first and second groove branches of each first Y-shaped groove being arranged relative to the third and fourth groove branches of each second Y-shaped groove that each inlet port of the plurality of first Y-shaped grooves is connected to the outlet ports of two of the plurality of second Y-shaped grooves, and each outlet port of the plurality of second Y-shaped grooves is connected to the inlet ports of two of the plurality of first Y-shaped grooves.

7. The friction disk of claim 6, wherein:
the stems of the first Y-shaped grooves extend radially outwardly from the inner edge and the stems of the second Y-shaped grooves extend radially inwardly from the outer edge and are respectively radially aligned with the stems of the first Y-shaped grooves such that the inlet and outlet ports are aligned with each other so that a radial line passes through the inlet and outlet ports and through a center of the friction disk.

8. (canceled)

9. (canceled)

10. (canceled)

11. The friction disk of claim 7, wherein:
third and fourth groove branches of each of the second Y-shaped grooves are respectively connected to, and form intersections with, first and second groove branches of each of the first Y-shaped grooves.

12. The friction disk of claim 6, wherein:
the stems of the second Y-shaped grooves each have a first cross-sectional area that is less than a second cross-sectional area of each of the stems of the first Y-shaped grooves.

13. (canceled)
